(19) United States
(12) Patent Application Publication
(10) Pub. No.: US 2021/0324790 A1
(43) Pub. Date: Oct. 21, 2021

(54) Single unit compact Rotary Combustion engine and Electric motor

(71) Applicant: ARVIND KUMAR, IRVIND, TX (US)

(72) Inventor: ARVIND KUMAR, IRVIND, TX (US)

(21) Appl. No.: 16/852,407

(22) Filed: Apr. 18, 2020

(51) Int. Cl. F02B 53/14; F01C 11/00; F02B 55/10; B60K 6/40

(52) U.S. Cl. CPC F02B 53/14; F01C 11/00; B60Y 2200/92; B60K 6/40; F02B 55/10

(57) ABSTRACT

A new method and approach to have a compact engine having capability of running on both Fuel and Electricity. Engine will be capable of giving high power and better efficiency based on need. Engines can be operated together as well as independently while giving an option to choose the fuel, power and efficiency.

### BACKGROUND OF INVENTION

Electric cars are getting more popular, but the challenge is the charging capacity and availability of charging options everywhere. For longer range electric cars, higher capacity battery is required whereas generally people travel long distances once in a week or month. So, for city travel also they need to have higher range cars hence higher cost. Also, electric cars are not practical solutions in remote areas or military vehicles where availability of electric charge is a problem.

This invention is around a compact single unit fuel engine and electric engine. To make this engine compact a Rotary engine with extended eccentric shaft having inbuilt electric rotor is used. So, customer need not to have high capacity batteries. They have capacity of City range and can use fuel engine when travelling far. Also, both the engines can be operated independently and together in order to achieve high power or efficiency based on need.

Other hybrid engines use piston engines which makes the engine heavy, costly and bulky. Whereas current invention makes the unit compact and less costly.

### DESCRIPTION OF DRAWINGS

On Page 1:

FIG. 1 is Isometric (Assembled) 3D view of the Unit.

FIG. 2 is Exploded (dissembled) 3D view of the unit showing each component.

On Page 2:

FIG. 3 is Top view of assembled unit.

FIG. 4 is Front view of the assembled unit.

FIG. 5 is Side view of assembled unit.

FIG. 6 is Sectional view of assembled unit.

On Page 3:

FIG. 7 is diagram of the extended eccentric shaft with inbuild rotor for electric motor.

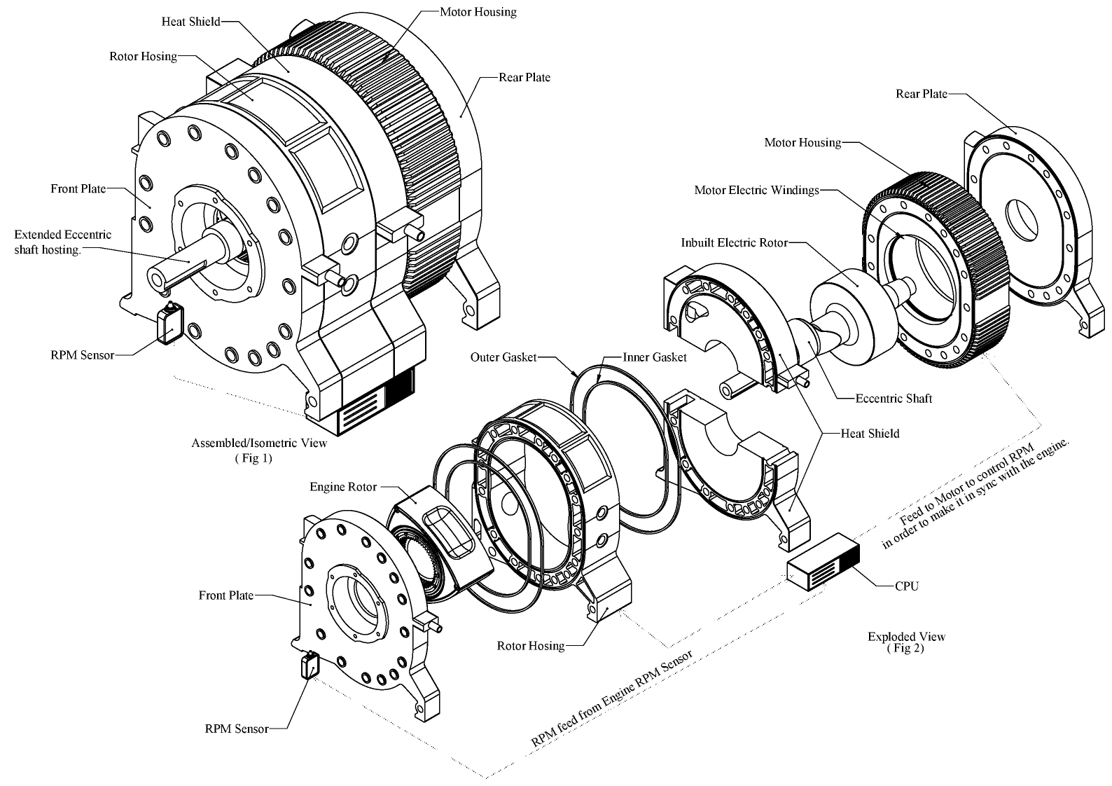

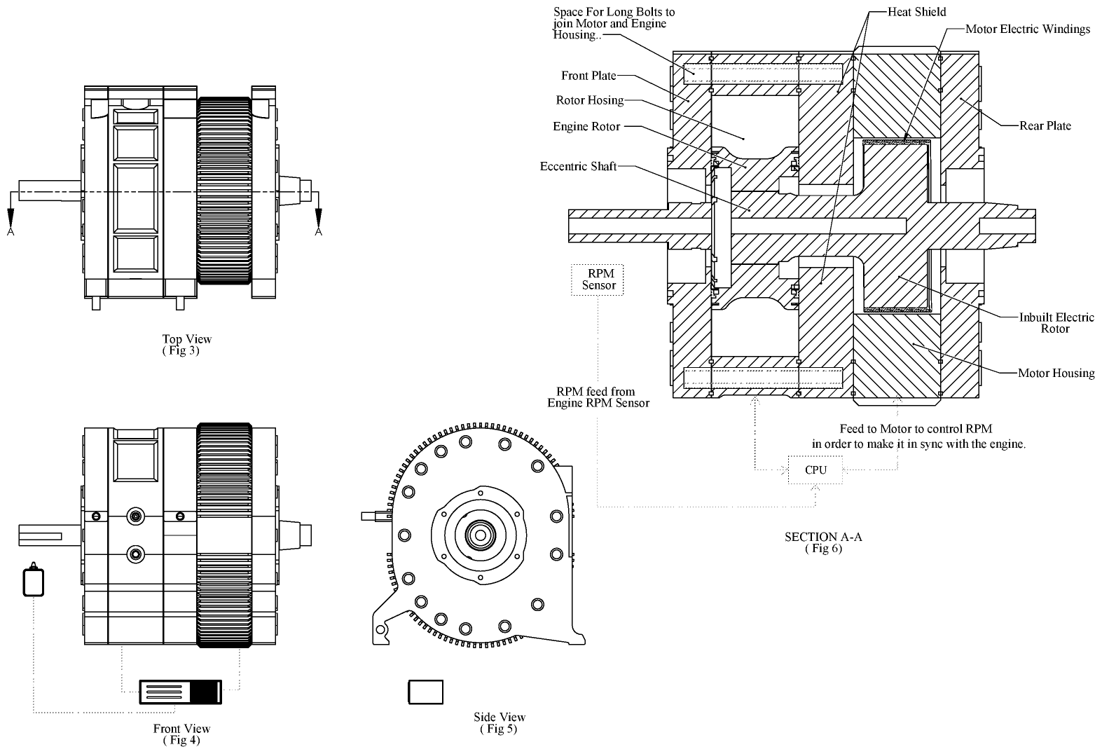

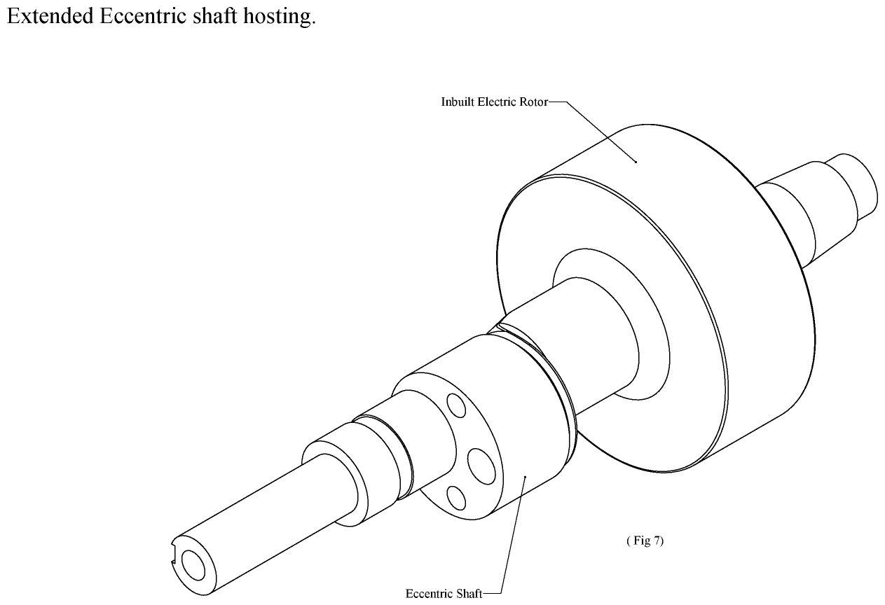

### DESCRIPTION OF INVENTION

This compact integrated engine will have a single extended eccentric shaft used in Rotary engine and will host the rotor of the AC motor as well, it is the key component of this design. Housing of both engine and motor will be bolted together after doing necessary component assembly. RPM feed from the Engine will be passed to the CPU in order to control the frequency of current passed to the motor, hence making the RPM of the electric motor in sync. Below is the detailed description of each component.
1. Extended Eccentric shaft hosting Electric rotor and engine rotor: This is the key component of this engine. Same eccentric shaft will be used in both Rotary engine and AC electric motor units. Same shaft will host a rotor at the rotary fuel engine side and an in-built rotor for the electric motor. Single shaft will make the design compact. This can be further classified as
1.1 Eccentric shaft: Rotary engine side part of shaft which will host Fuel engine rotor.
1.2 Inbuilt Electric Rotor: electric motor side component of eccentric shaft which will act as rotor for the electric motor.
2. Engine Rotor: Usual component of Rotary engine, no design or specification changes.
3. Engine housing: Customized housing which holds the Rotary engine side components. It will be casted with coolant flow ways, ports and will hold the new eccentric shaft, heat shield, long bolts, spark plugs etc.
4. Motor Housing: customized motor housing will hold the extended eccentric shafts inbuilt rotor.
5. Motor electric windings: Usual AC electric motor wire windings. Eccentric shaft rotor needs to be customized if the DC motor to be used in the unit.
6. Long Bolts: Forged high strength multiple bolts, to hold and assemble Rotary engine housing, electric motor housing and heat shield inline and sealed.
7. RPM Sensor: sensor to read rpm and pass it to CPU.
8. Heat shield: Casted heat shield with high temperature fireproof coatings, gaskets and coolant flow ways.
9. CPU: While controlling all necessary functions of Fuel engine and electric motor, CPU will control frequency to motor based on engine RPM. CPU will use the feed from RPM sensor and control the frequency of current to motor in order to make the RPM in sync for both engine and motor.
10. Gaskets: They are used to seal the unit, mainly in Fuel engine side where pressure will be high.
11. Front Plate and Rear Plate: End of unit at rotary engine side and electric motor side and holds the eccentric shaft.
   How it will Work:

Any unit can be started independently as well as together.

To start the Fuel engine independently electric motor will be started, which will act as a starter to engine. Engine will get started while taking fuel from fuel pump and doing combustion with the spark plugs. After initial start current will not be passed to motor which will make only fuel engine running.

To run both the unit together CPU will keep passing the current to electric motor by making the RPM in sync at both sides with the help of RPM sensor while controlling the frequency of current accordingly.

To start motor independently, current will be passed to electric motor, but fuel pump will remain off and there will not be any current passed to spark plugs. This will make electric motor run independently.

### Advantages:

It can act as a pure electric engine in urban areas where charging is available easily and fuel engine in remote areas. By doing so, high capacity batteries will not be required which is a major cost in any electric car.

It can produce high starting torque and power while having both the engines on and once accelerated one engine can be switched off. This function can be controlled by the CPU based on user setup.

Unlike piston engines, Rotary engines have 3 power strokes in one rotation which make them more powerful. So, this combination of Electric and Rotary engine gives high power while keeping the unit compact and enabling the option to choose efficiency.

As electric motor is inbuild in the unit so no need to have a starter as electric motor can perform that function too. Hence reducing the size and weight of unit.

1. An integrated Rotary engine and electric motor (engine) comprising a single shaft makes it very compact.

2. An integrated unit of rotary engine and electric motor is separated by Heat shield with coolant flow-ways hence both engines can be maintained at different temperature.

3. An integrated unit comprising of Rotary fuel Engine and electric motor use different fuel type and fuel source; hence both the engines can be operated together as well as independently.
